(19) United States
(12) Patent Application Publication
(10) Pub. No.: US 2026/0243371 A1
(43) Pub. Date: Aug. 20, 2026

(54) SMART CLEAT FOR PREVENTING HIGH-CURRENT AND HIGH-VOLTAGE CABLE SAFETY ACCIDENT

(71) Applicant: ITR CO., LTD, Daejeon (KR)

(72) Inventors: Tae Sung PARK, Daejeon (KR); Hyun Jun KANG, Daejeon (KR); Byul PARK, Daejeon (KR); Youn Seuk PARK, Daejeon (KR)

(73) Assignee: ITR CO., LTD, Daejeon (KR)

(21) Appl. No.: 19/160,432

(22) PCT Filed: Feb. 27, 2023
(86) PCT No.: PCT/KR2023/002702

§ 371 Date: Aug. 27, 2025

(30) Foreign Application Priority Data
Feb. 27, 2023 (KR) 10-2023-0025561

(51) Int. Cl. F16L 3/223; F16B 2/12

(52) U.S. Cl. CPC F16L 3/2235; F16B 2/12

(57) ABSTRACT

The present invention relates to a smart cleat for preventing a high-current and high-voltage cable safety accident in a power plant and the like, which can prevent the high-current and high-voltage cable from moving and monitor a state, such as a change in an electromagnetic field within the cable, cable temperature, and the like, thereby preventing an accident in advance. To address the issue, the smart cleat for preventing a high-current and high-voltage cable safety accident according to the present invention includes a state detection unit including: a vibration sensor unit for detecting vibration generated from a settled cable in real time; a temperature sensor unit for detecting a temperature change of the cable in real time; a communication unit for wiredly or wirelessly transmitting information detected by the vibration sensor unit and the temperature sensor unit; and a power supply unit for applying power to the vibration sensor unit, the temperature sensor unit, and the communication unit, so that the vibration and temperature of the cable can be monitored in real time through information of the cable detected by the state detection unit.

### TECHNICAL FIELD

The present disclosure relates to a smart cleat for preventing a high-current and high-voltage cable safety accident, and more specifically, to a smart cleat for preventing a high-current and high-voltage cable safety accident by firmly securing the high-current and high-voltage cable to a structure, preventing them from moving unintentionally.

### BACKGROUND ART

Generally, high-current and high-voltage power cables (hereinafter referred to as “cables”), such as those used in power plants, and so on can be moved unintentionally due to the electromagnetic force (magnetic field) generated from the cables during current flow, resulting in serious problems such as cable damage and short circuits, and to prevent this, cleats for enclosing the cables are installed at predetermined intervals to firmly secure them to the structure.

Related technology for this purpose includes a hinged injection-molded cable cleat assembly disclosed in Registered Korean Patent No. 2403436 (hereinafter referred to as “patent document”).

The patent document described above includes an upper hinge fixing metal plate formed with a spot welded part at one end including a hinge fixing part, and a bent end formed at the other end, an upper engineering plastic injection cleat including a curved portion at a lower portion in which the upper hinge fixing metal plate is disposed and injection-molded and curved, and an upper flange portion formed at an upper end, a lower hinge fixing metal plate formed with a spot welded part at one end including a hinge fixing part, and a bent end formed at the other end, a lower engineering plastic injection cleat in which the lower hinge fixing metal plate is disposed at a lower end and injection-molded and forms a flat surface, the lower engineering plastic injection cleat being formed with a lower flange portion at an upper end, which is bent at a near right angle at an end of the flat surface and which has a corresponding shape and contacts the upper flange portion, a hinge rod inserted into the hinge fixing parts of the upper and lower hinge fixing metal plates, and a fastening bolt part assembled to the upper and lower flange parts, wherein a curved portion is formed in the middle of the upper engineering plastic injection cleat, a plurality of reinforcing protrusions are formed in a longitudinal direction on the curved portion, a flat upper flange part is formed on the upper part of the upper engineering plastic injection cleat, and a through hole is perforated on the upper flange part.

However, the related cable cleat described above only serves to physically secure the cable to the structure, and even after the cable is secured by the cable cleat in the manner described above, the cable movement occurs continuously due to the influence of the electromagnetic force (magnetic field) generated by the current flowing through the cable, and the load is concentrated on the cable cleat that prevents it, and there is a concern that the cable cleat or the fixed part of the structure that secures the cable cleat may be damaged due to the accumulation of this load.

When the cable cleat is unintentionally released as described above, there is a concern that the irregular movement of the cable may cause serious damage to adjacent facilities and equipment, and may even lead to personal injury when workers are near the cable.

Therefore, it requires workers to continuously check the fastening state of the cable cleats and the fixing parts of the structure, but since workers only check the appearance of the cable cleats or the structure, there is a limit to preventing safety accidents in advance.

Therefore, there is a need to develop a cable cleat with an improved structure that can sense changes in the cable condition through the cable cleat and prevent safety accidents in advance.

### DETAILED DESCRIPTION OF INVENTION

### Technical Problem

The present disclosure has been devised to solve the problems of the related cable cleat described above. It is an object of the present disclosure to provide a smart cleat for preventing a high-current and high-voltage cable safety accident in a power plant and the like, which can prevent a high-current and high-voltage cable from moving while also monitoring a state such as a change in an electromagnetic field within the cable, cable temperature, and the like, thereby preventing an accident in advance.

### Technical Solution

According to an aspect of the disclosure, a smart cleat for preventing a high-current and high-voltage cable safety accident may include a state sensing unit including a vibration sensor unit that senses vibration occurring in a secured cable in real time, a temperature sensor unit that senses a temperature change in the cable in real time, a communication unit that transmits information sensed by the vibration sensor unit and the temperature sensor unit via wire or wirelessly, and a power supply unit that applies power to the vibration sensor unit, the temperature sensor unit, and the communication unit, and the smart cleat is configured to monitor the vibration and temperature of the cable in real time through the information of the cable sensed by the state sensing unit.

According to some aspects, the smart cleat may include a cleat body including first and second mounting brackets with a predetermined vertical length, which are installed at a predetermined interval, a plurality of cable fixture holes installed in a space between the first and second mounting brackets and mutually assembled to enclose an outer surface of the cable from upper and lower sides of the cable, a plurality of restraining members engaged by insertion with the first and second mounting brackets to secure the cable fixture holes, and a fastener engaged by insertion with the first and second mounting brackets to cover a top of the cable fixture holes.

In addition, according to an aspect of the disclosure, teeth may be formed along a vertical length on one side of each of the first and second mounting brackets, and the restraining members and the fastener may be provided with locking protrusions which are caught by the teeth to prevent separation in a reverse direction.

Additionally, according to an aspect of the present disclosure, the cable fixture hole may each include an upper fixing body including a plurality of cable seating grooves having a semicircular shape, which are formed at predetermined intervals on a lower surface, and a lower fixing body including a plurality of cable seating grooves having a semicircular shape, which are formed at predetermined intervals on an upper surface.

Additionally, according to an aspect of the present disclosure, the upper and lower fixing bodies may include grooves and protrusions corresponding to each other on upper and lower surfaces, and the upper and lower fixing bodies may be configured to be continuously assembled by repeatedly fitting in a vertical direction according to the number of cables and secured.

### Effects of Invention

According to the aspects of the disclosure, by sequentially and repeatedly stacking and assembling the upper and lower fixing bodies on the cleat body, a desired number of cable seating grooves to secure the cables can be easily formed, and further, the upper and lower fixing bodies can be easily fixed in close contact with the cleat body using the restraining members.

In addition, it is possible to monitor in real time the vibration and temperature changes occurring in the cable secured in the cable seating groove through the state sensing unit built into the fastener of the cleat, thereby enabling estimation of the fatigue limit of the cleat and accordingly, timely inspection and prevention of safety accidents.

### BRIEF DESCRIPTION OF THE DRAWINGS

FIG. 1 is a schematic diagram showing an example of a smart cleat for preventing high-current and high-voltage cable safety accidents according to an aspect of the disclosure.

FIG. 2 is a perspective view showing an example of the cleat unit according to an aspect of the disclosure.

FIG. 3 is an exploded perspective view of FIG. 2.

FIG. 4 is a front view of FIG. 2.

FIG. 5 is a perspective view showing an example of a bracket and a fixing body according to an aspect of the disclosure.

FIG. 6 is an exploded perspective view showing an example of cable fixture holes according to an aspect of the disclosure.

FIG. 7 is a front view of FIG. 6.

FIG. 8 is a diagram showing an example of the cable fixture holes in assembled state according to an aspect of the disclosure.

FIGS. 9A and 9B are perspective views showing an example of a restraining member according to an aspect of the disclosure.

FIG. 10 is a perspective view showing an example of a cleat cover according to an aspect of the disclosure.

FIG. 11 is a cross-sectional view showing an example of a cleat unit according to an aspect of the disclosure.

[Description of Reference Numerals]

| | |
|---|---|
| 1: Cleat | 2: Receiver |
| 3: Monitoring unit | 10: Fixing bracket |
| 11: Fixing part | 12: Support part |
| 20: Cleat body | 21: Base part |
| 21A: Coupling groove | 22: First mounting bracket |
| 23: Second mounting bracket | 30: Cable fixture hole |
| 30A: Upper fixing body | 30B: Lower fixing body |
| 31A: Side coupling groove | 31B: Side coupling protrusion |
| 32A: Lower coupling protrusion | 32B: Upper coupling groove |
| 33A: Upper coupling groove | 33B: Lower coupling protrusion |
| 40A, 40B: Restraining member | 41: Restraining body |
| 42: Through hole | 43: Locking protrusion |
| 44: Insertion groove | 45: Pressing protrusion |
| 50: Fastener | 51: Fastener body |
| 52: Through hole | 53: Locking protrusion |
| 54: Cover | 60: State sensing unit |
| 61: Vibration sensor unit | 62: Temperature sensor unit |
| 63: Wireless communication unit | 64: Power supply unit |
| H: Cable seating groove | T: Teeth |

### MODE FOR CARRYING OUT THE INVENTION

Hereinafter, preferred embodiments of the present disclosure will be described in detail with reference to the accompanying drawings.

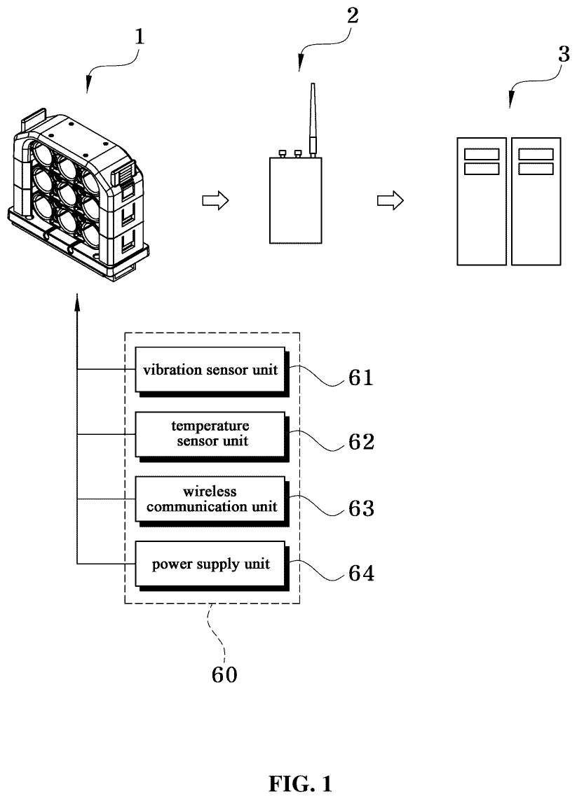

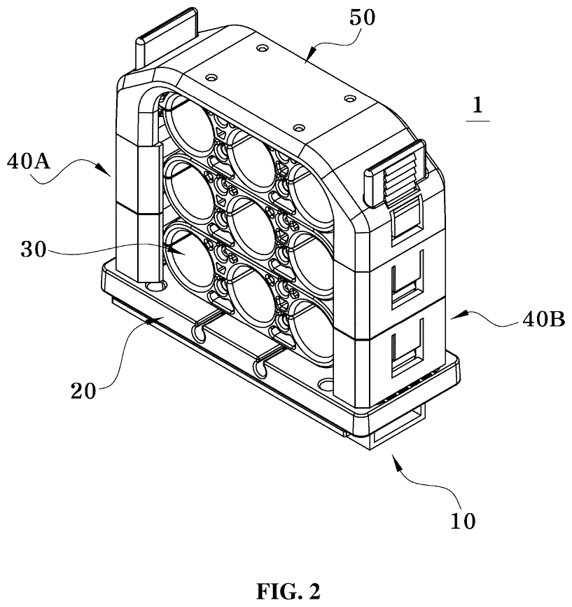

It is an object of the present disclosure to provide the a smart cleat for preventing a high-current and high-voltage cable safety accident in a power plant and the like, which can prevent a high-current and high-voltage cable from moving while also monitoring a state such as a change in an electromagnetic field within the cable, cable temperature, and the like, thereby preventing an accident in advance, and as shown in FIGS. 1 to 3, the smart cleat of the present disclosure includes a fixing bracket 10, a cleat body 20, a cable fixture hole 30, restraining members 40A and 40B, a fastener 50, and a state sensing unit 60.

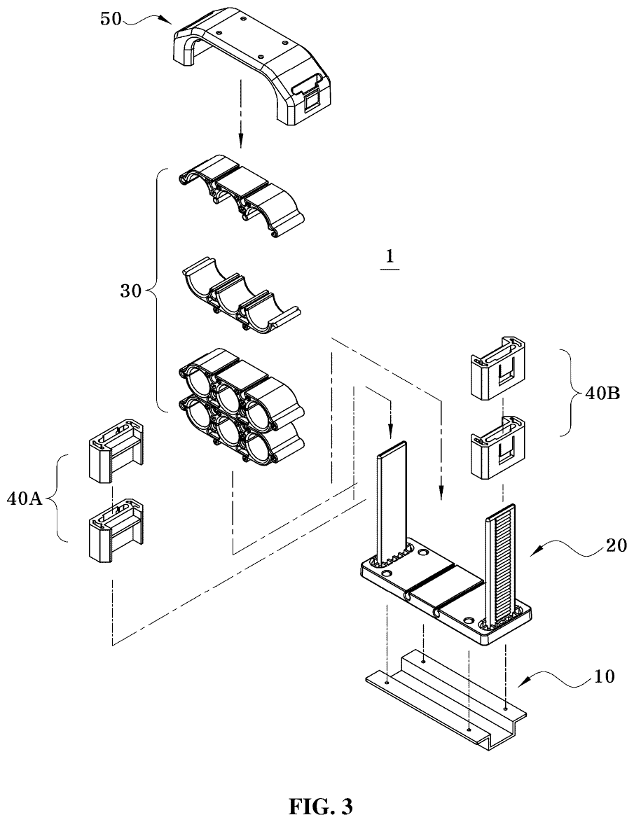

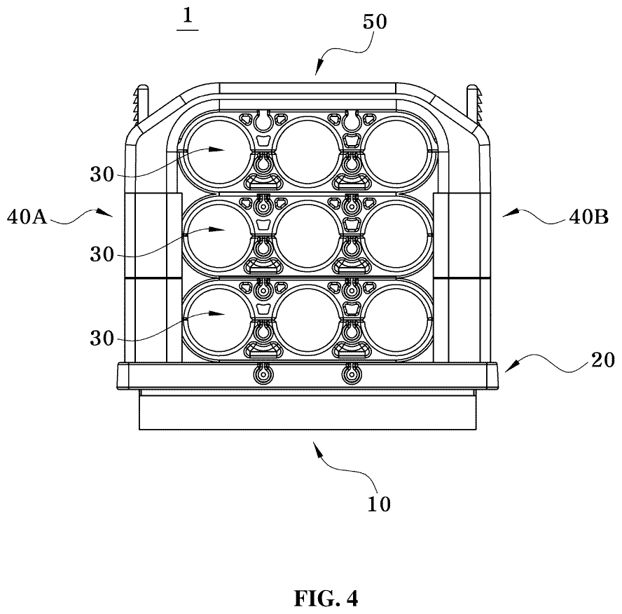

The fixing bracket 10 is configured to firmly secure the cleat body 20 to be described below to a structure (not shown) such as a floor, and the fixing bracket 10 may include a fixing part 11 of a predetermined length buried in a floor, etc. by a predetermined depth or fixed by an anchor bolt, etc. as shown in FIGS. 3 to 5, and a pair of support parts 12 formed by bending symmetrically to each other in “L” and “reversed L” shapes along both sides of the fixing part 11 in the longitudinal direction.

At this time, the pair of support parts 12 may be provided with a plurality of through holes (not marked in the drawings) so as to be assembled to a base part 21 of the cleat body 20 (to be described below) with fastening members such as bolts and nuts.

The fixing bracket 10 may also be modified into various forms according to the installation environment of the cleat 1.

The cleat body 20 is configured to be seated and fixed on the fixing bracket 10, with a plurality of cable fixture holes 30 (to be described below) seated and fixed therein.

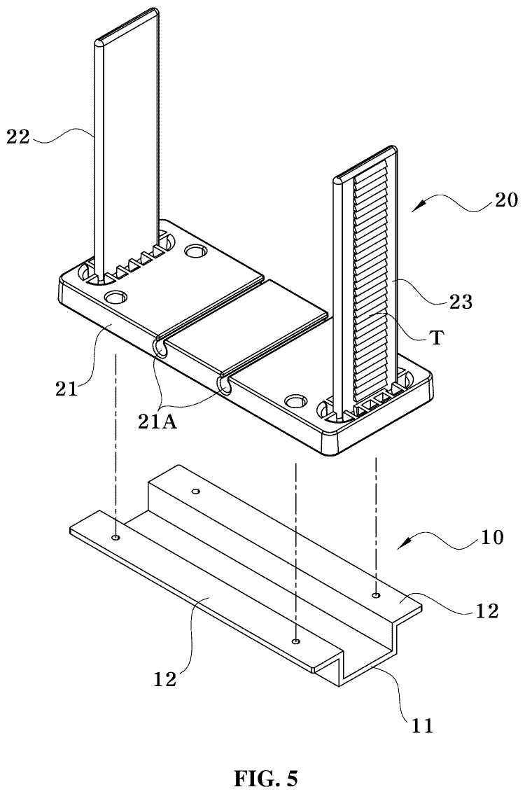

As shown in FIG. 5, the cleat body 20 includes the base part 21 with a predetermined width and length in the horizontal direction, which is positioned above the fixing bracket 10, a first mounting bracket 22 with a predetermined vertical length, which is positioned at one end of the base part 21, and a second mounting bracket 23 with a predetermined vertical length, which is positioned at the other end of the base part 21.

At this time, the first and second mounting brackets 22 and 23 may be integrally formed with the base part 21, or may be manufactured separately and then assembled together through fastening members such as bolts and nuts.

In addition, teeth T are formed along a vertical length on one side (on opposite surfaces or surfaces facing each other) of each of the first and second mounting brackets 23 and 24, in which the teeth T are preferably configured such that the restraining members 40A and 40B (to be described below) are allowed to be inserted without any obstruction when inserted from above in a downward direction, while the teeth T prevent the locking protrusions 43 of the restraining members 40A and 40B from being unintentionally disengaged when the restraining members 40A and 40B are lifted from below in an upward direction.

For example, examples of the teeth T may be triangular protrusions extending from the sides of the first and second mounting brackets 23 and 24, in which an upper surface portion of the triangular projection may be formed to be inclined at a predetermined angle, while a lower surface portion may be formed horizontally to form a right angle with the first and second mounting brackets 23 and 24.

Meanwhile, the base part 21 may include a coupling groove 21A with a predetermined diameter, which is engaged with a lower coupling protrusion 33B formed on a lower fixing body 30B of the cable fixture hole 30, which will be described below.

At this time, the coupling groove 21A may be configured with a groove and a protrusion in the shape of an “(” or a groove and a protrusion in the shape of a dovetail joint so that the coupling protrusion can slide in the horizontal direction for assembly but cannot be disengaged in the vertical direction.

The cable fixture holes 30 are stacked vertically and assembled according to the number of cables fixed through the cleat 1, enclosing outer surfaces of the cables and fixing them in position.

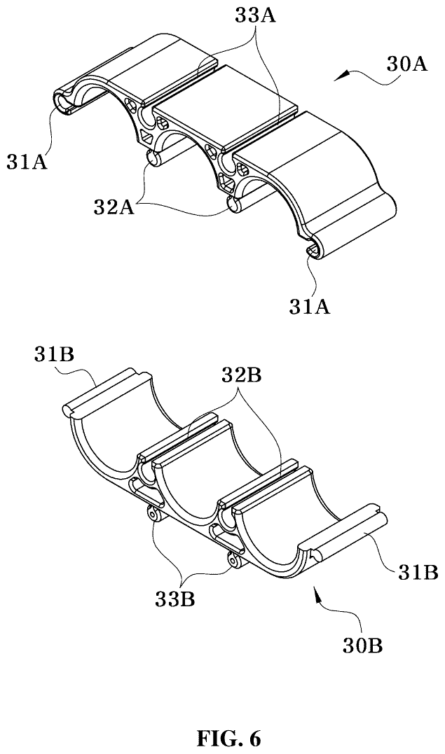

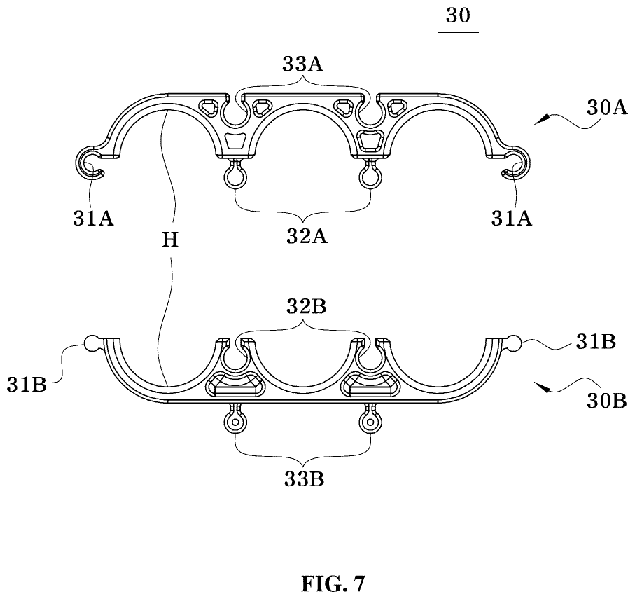

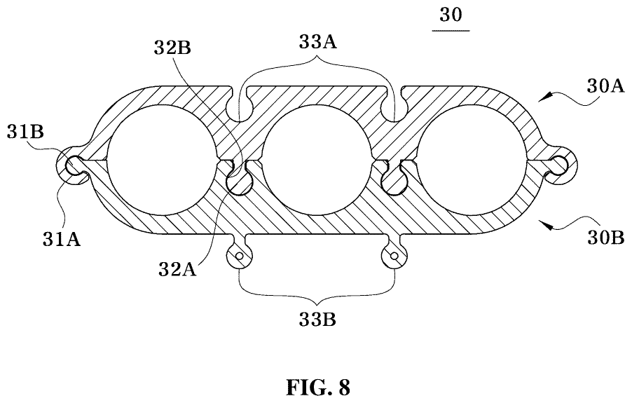

As shown in FIGS. 6 to 8, sets of cable fixture holes 30 may be provided, in which each set may include an upper fixing body 30A and the lower fixing body 30B which are vertically engaged and disengaged.

At this time, a plurality of cable seating grooves H having a semicircular shape are formed on a lower surface of the upper fixing body 30A at predetermined intervals to enclose upper outer surfaces of the cables, and a plurality of cable seating grooves H having a semicircular shape corresponding in position to the cable seating grooves H of the upper fixing body 30A are formed on the lower fixing body 30B to enclose lower outer surfaces of the cable.

In addition, side coupling grooves 31A of a predetermined size may be formed on both ends of the upper fixing body 30A in the horizontal direction, and side coupling protrusions 31B to be coupled to the side coupling grooves 31A of the upper fixing body 30A, having a length in the horizontal direction, may be formed on both ends of the lower fixing body 30B.

In addition, lower coupling protrusions 32A, having a length in the horizontal direction, may be formed on the lower surface of the upper fixing body 30A between the cable seating grooves H, and upper coupling grooves 32B may be formed on the upper surface of the lower fixing body 30B between the cable seating grooves H to be coupled with the lower coupling protrusions 32A.

In addition, upper coupling grooves 33A, having a length in the horizontal direction, may be formed at predetermined intervals on an upper surface of the upper fixing body 30A, and lower coupling protrusions 33B, having a length in the horizontal direction, may be formed at predetermined intervals on a lower surface of the lower fixing body 30B, in which, when the plurality of cable fixture holes 30 are stacked in the vertical direction through the upper coupling grooves 33A and the lower coupling protrusions 33B, the lower fixing body 30B positioned on the upper side is fitted and assembled in the upper fixing body 30A positioned on the lower side, allowing them to be coupled and securely fixed.

It has been illustrated and described above that the side coupling grooves 31A, the lower coupling protrusions 32A, and the upper coupling grooves 33A are formed on the upper fixing body 30A, and the side coupling protrusions 31B, the upper coupling grooves 32B, and the lower coupling protrusions 33B are formed on the lower fixing body 30B, but it should be appreciated that the positions of the coupling grooves and the coupling protrusions of the upper and lower fixing bodies 30A and 30B may be reversed relative to each other.

The restraining members 40A and 40B are configured to be engaged by insertion with the first and second mounting brackets 22 and 23 of the cleat body 20 from opposite directions, thus fixing (restraining) the cable fixture holes 30 stacked on the base part 21 and positioned between the first and second mounting brackets 22 and 23.

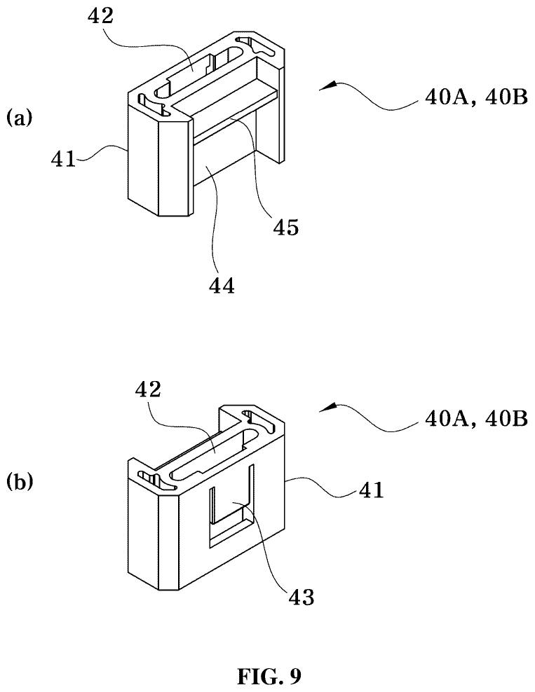

As shown in FIGS. 3 and 9A and 9B, the restraining members 40A and 40B may include a rectangular block-shaped restraining body 41 of a predetermined size; a through hole 42 of a predetermined size formed by penetrating the restraining body 41 in a vertical direction to receive the first and second mounting brackets 22 and 23 inserted therethrough; a locking protrusion 43 of a predetermined size, which is protruding from one inner side of the through hole 42 and locked with the teeth T of the first and second mounting brackets 22 and 23; an insertion groove 44 formed to a predetermined depth along a vertical length on the opposite side to the side where the locking protrusion 43 is formed; and a pressing protrusion 45 with a predetermined width, which is formed horizontally across the insertion groove 44.

At this time, the locking protrusion 43 is configured with a free end that is elastically deformable, allowing an operator to pull the free end of the locking protrusion 43 outward to release the restraining members 40A and 40B from their fixed state when necessary.

In addition, a side end of the cable fixture hole 30 is inserted into the insertion groove 44 to a predetermined depth, thus securing the cable fixture hole 30 seated on the base part 21 of the cleat body 20 and preventing movement in the front and rear directions.

At this time, the pressing protrusion 43 downwardly presses the cable fixture holes 30 inserted in the insertion groove 44, or to be more specific, downwardly presses the upper surface of the side coupling protrusion 31A of the upper fixing body 30A, thereby securing the cable fixture holes 30 and preventing movement in the vertical direction.

That is, the lower coupling protrusion 33B of the bottom surface of the lower fixing body 30B is inserted into the coupling groove 21A of the base part 21 so that the lower fixing body 30B is fixed between the first and second mounting brackets 22 and 23, then the cable to be fixed is seated in the cable seating groove H of the lower fixing body 30B, then the upper fixing body 30A is fitted and assembled on the lower fixing body 30B on which the cable is seated, and then the pair of restraining members 40A and 40B are inserted into the first and second mounting brackets 22 and 23 to face each other, so that both ends of the cable fixture hole 30 are positioned and restrained in the insertion grooves 44 of the restraining members 40A and 40B.

At this time, the pressing protrusion 45 of the restraining members 40A and 40B downwardly presses an upper portion of the side coupling groove 31A of the upper fixing body 30A, and in this state, the restraining members 40A and 40B are prevented from being separated in the reverse direction by the structure of the teeth T and the locking protrusion 43, such that the upper and lower fixing bodies 30A in the assembled state are securely fixed and prevented from being moved in up, down, left, and right, and front and rear directions.

As described above, one set of upper and lower fixing bodies 30A and 30B may be fixed through the restraining members 40A and 40B to secure the cable, and then the lower coupling protrusions 33B of another set of lower fixing bodies 30B may be inserted into and fixed to the fixed upper coupling grooves 33A of the upper fixing body 30A as necessary, and a desired number of cables may be seated by repeating this process.

The fastener 50 is configured to cover and secure the top, preventing the cable fixture hole 30 positioned at the top from becoming detached once the plurality of cable fixture holes 30 are stacked in the vertical direction and installed on the cleat body 20.

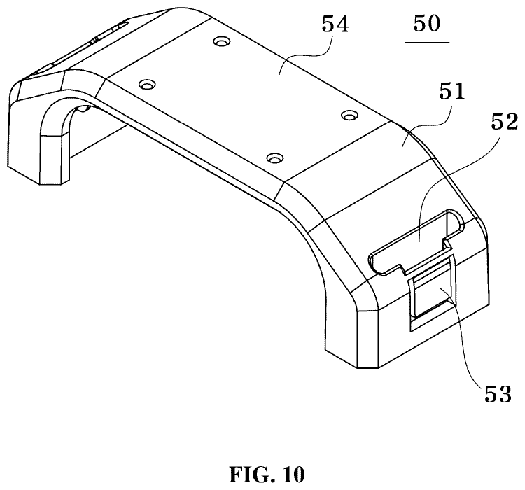

As shown in FIG. 10, the fastener 50 includes: a fastener body 51 formed integrally with a horizontal portion with a predetermined length in the horizontal direction and vertical portions vertically extending a predetermined length downward from both ends of the horizontal portion; a pair of through holes 52 each extending through the vertical portions of the fastener body 51 in the vertical direction; and locking protrusions 53 positioned on both sides of the vertical portions of the fastener body 51 and protruding into the through holes 52.

Similar to the locking protrusions 43 of the restraining members 40A and 40B, the locking protrusions 53 may also be configured with free ends that are elastically deformable, allowing the operator to pull the free ends of the locking protrusions 53 outward to release the fastener 50 from its fixed state.

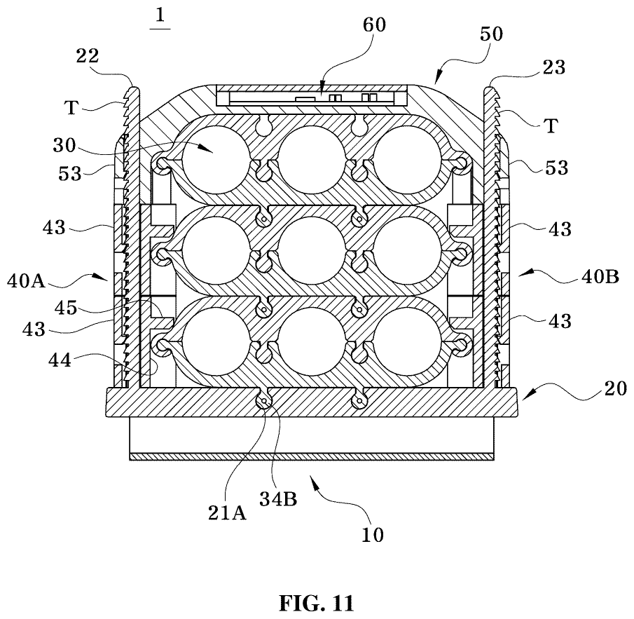

In addition, as shown in FIG. 11, a certain depth of accommodation space (not marked in the drawings) with an open upper side may be further formed in the fastener body 51 to accommodate the state sensing unit 60 (to be described below), and in this case, a separate cover 54 for covering the accommodation space may be further provided.

The state sensing unit 60 is configured to sense in real time the vibration and temperature changes occurring in the cables secured in the cable fixture holes 30 of the cleat 1 and transmit the sensed result to a monitoring unit 3 which may be separately provided at a remote location.

As shown in FIG. 1, the state sensing unit 60 may include: a vibration sensor unit 61 that senses in real time the vibration occurring in the secured cables; a temperature sensor unit 62 that senses changes in temperature of the cables in real time; a communication unit 63 that transmits information sensed by the vibration sensor unit 61 and the temperature sensor unit 62 via wire or wirelessly; and a power supply unit 64 that supplies power to the vibration sensor unit 61, the temperature sensor unit 62, and the communication unit 63.

At this time, the vibration sensor unit 61 is configured to sense vibrations occurring due to the magnetic field of the current flowing along the cables, and by sensing the intensity of the vibration occurring in the cables or counting the number of vibration events, the vibration sensor unit 61 can estimate the load repeatedly applied to the cleat 1, and based on the results, it is possible to estimate and inspect the service life of the cleat 1.

In addition, when there is a significant change in the intensity of vibration, for example, when a vibration with a vibration amplitude or intensity greater than 5 to 10% compared to the previous vibration intensity or amplitude is sensed, it may be estimated that a partial damage occurred to the cleat 1, and in this case, instructions may be output by the monitoring unit 3 together with the position information of the cleat 1 to request the operator to promptly inspect the cleat 1 at that position.

When a temperature value sensed through the temperature sensor unit 62 exceeds a reference value, it may be determined that there is an insulation abnormality in the cable, a fire around the cable, or the like, in which case instructions may be output by the monitoring unit 3 to request inspection of the cable at that position.

At this time, the power supply unit 64 may be configured to apply external commercial power or to apply power through a built-in battery, or alternatively, it may be configured to automatically generate (harvest) and supply electric energy using the induced electromotive force of current flowing through the cable, and in this case, the state sensing unit 60 may be configured to include a ferrite core (magnetic core) for induced electromotive force and an induced electromotive force generation unit formed by winding a coil to enclose an outer surface of the ferrite core.

Meanwhile, in the cleat 1 according to an aspect of the disclosure, vibration and temperature information sensed by the state sensing unit 60 is received through a separately installed receiver 2, and the information received through the receiver 2 is transmitted in real time to the monitoring unit 3 through the monitoring server, thereby enabling the monitoring unit 3 to sense abnormal vibration or temperature of the cable sensed by the cleat 1 in real time.

At this time, the monitoring unit 3 may be configured to detect cumulative fatigue of the cleat 1 based on the intensity and duration of the vibration occurring in the cable, and estimate the fatigue limit of the cleat 1 so as to enable timely inspection and replacement of the cleat 1 by the operator.

Additionally, the monitoring unit 3 may sense abnormalities, such as insulation breakdown, etc., based on the changes in the cable temperature, and when needed, may output instruction to inspect the cable at that position to prevent safety accidents caused by the insulation breakdown, etc. of the cable.

In the cable fixture hole 30, to facilitate the application of an asterisk array structure (or loss reduction structure), which allows the magnetic fields generated by the R, S, and T phase cables to mutually cancel out according to the positional relationship of the R, S, and T phase cables being seated (secured), a fixing guide unit (not shown) to guide the cable fixing position may be further marked in a combination of letters, shapes, and colors according to the position of the cable seating groove H.

As described above, according to the aspects of the disclosure, by sequentially and repeatedly stacking and assembling the upper and lower fixing bodies on the cleat body, a desired number of cable seating grooves to secure the cables can be easily formed, and further, the upper and lower fixing bodies can be easily fixed in close contact with the cleat body using the restraining members.

In addition, it is possible to monitor in real time the vibration and temperature changes occurring in the cable secured in the cable seating groove through the state sensing unit built into the fastener of the cleat, thereby enabling estimation of the fatigue limit of the cleat and accordingly, timely inspection and prevention of safety accidents.

The above description has been illustrated by means of drawings showing preferred embodiments and assigning drawing symbols and designations to the configurations shown in the drawings for ease of explanation, but this is only one embodiment of the invention and should not be construed as limiting the scope of the claims to the shapes shown in the drawings and the designations assigned thereto, and it goes without saying that, from the description, the change of the present disclosure to various predictable shapes and the simple substitution of the present disclosure to a configuration having the same function are within a range that may be changed to easily implement the present disclosure by a person skilled in the art.

1. A smart cleat for preventing a high-current and high-voltage cable safety accident, wherein the smart cleat is configured to secure a high-current and high-voltage cable and comprises a state sensing unit comprising:
a vibration sensor unit that senses vibration occurring in a secured cable in real time;
a temperature sensor unit that senses a temperature change in the cable in real time;
a communication unit that transmits information sensed by the vibration sensor unit and the temperature sensor unit via wire or wirelessly; and
a power supply unit that supplies power to the vibration sensor unit, the temperature sensor unit, and the communication unit, and
the smart cleat is configured to monitor the vibration and temperature of the cable in real time through the information of the cable sensed by the state sensing unit.

2. The smart cleat according to claim 1, wherein the cleat includes:
a cleat body including first and second mounting brackets with a predetermined vertical length, which are installed at a predetermined interval;
a plurality of cable fixture holes installed in a space between the first and second mounting brackets and mutually assembled to enclose an outer surface of the cable from upper and lower sides of the cable;
a plurality of restraining members engaged by insertion with the first and second mounting brackets to secure the cable fixture holes; and
a fastener engaged by insertion with the first and second mounting brackets 23 and 24 to cover a top of the cable fixture holes 30.

3. The smart cleat according to claim 2, wherein
teeth are formed on one side of each of the first and second mounting brackets along a vertical length, and
the restraining members and the fastener are formed with locking protrusions that are caught by the teeth to prevent separation in a reverse direction.

4. The smart cleat according to claim 2, wherein the cable fixture holes each includes:
an upper fixing body including a plurality of cable seating grooves having a semicircular shape, which are formed at predetermined intervals on a lower surface; and
a lower fixing body including a plurality of cable seating grooves having a semicircular shape, which are formed at predetermined intervals on an upper surface.

5. The smart cleat according to claim 4, wherein
the upper and lower fixing bodies include grooves and protrusions corresponding to each other on upper and lower surfaces, and
the upper and lower fixing bodies are configured to be continuously assembled by repeatedly fitting in a vertical direction according to the number of cables and secured.

6. The smart cleat according to claim 3, wherein the cable fixture holes each includes:
an upper fixing body including a plurality of cable seating grooves having a semicircular shape, which are formed at predetermined intervals on a lower surface; and
a lower fixing body including a plurality of cable seating grooves having a semicircular shape, which are formed at predetermined intervals on an upper surface.
